(19) United States
(12) Patent Application Publication
(10) Pub. No.: US 2025/0269422 A1
(43) Pub. Date: Aug. 28, 2025

(54) JOINING METHOD, MANUFACTURING METHOD, AND IMAGE FORMING APPARATUS

(71) Applicant: CANON KABUSHIKI KAISHA, Tokyo (JP)

(72) Inventors: YOSHIRO NISHINO, Chiba (JP); HIROSHI CHIBA, Ibaraki (JP); TOMOHARU KITAJIMA, Ibaraki (JP); JUNICHI MOTEKI, Chiba (JP); AYUMU IWANAGA, Chiba (JP); SHIMPEI KAKIZAKI, Chiba (JP)

(21) Appl. No.: 19/057,812

(22) Filed: Feb. 19, 2025

(30) Foreign Application Priority Data
Feb. 22, 2024 (JP) 2024-025599

(51) Int. Cl. B21J 15/02; B41J 29/02; G03G 21/16

(52) U.S. Cl. CPC B21J 15/02; B41J 29/02; G03G 21/1619

(57) ABSTRACT

A joining method of joining a first metal sheet and a second metal sheet, the joining method including a fastening step of fastening the first metal sheet and the second metal sheet, which have been superposed on each other, by a fastening member at a fastening position, and a welding step of welding the first metal sheet and the second metal sheet, which have been superposed on each other, at a welding position, wherein, in a direction intersecting a sheet thickness direction of the first metal sheet, a distance between the fastening position and the welding position is set such that vapor generated between the first metal sheet and the second metal sheet during the welding step elastically deforms at least one of the first metal sheet and the second metal sheet.

### BACKGROUND

### Field

The present disclosure relates to a welding technology for a metal sheet with metallicity, such as a frame member to be used in manufacture of a frame body of an apparatus such as an image forming apparatus.

### Description of the Related Art

A frame body of an electrophotographic, ink-jet, or other image forming apparatus is formed by combining a plurality of frame members. As a joining method of fixing frame members together, joining with screw fixation, rivet joining, joining by welding, and the like are known. The joining method of fixing frame members together by welding can provide higher rigidity of the frame body structure as compared to other joining methods, and can secure stable positioning accuracy of the frame members, and hence the joining method by welding has been widely used. When joining by welding is performed, the frame members are heated during welding. This heat may cause distortion of the frame members.

In order to minimize distortion of the frame members, it is preferred that the amount of heat to be applied to the frame members be suppressed as much as possible. As a joining method of suppressing the amount of heat to be applied to the frame members, there is known a superposition joining method in which two frame members to be joined are arranged so that surfaces of the two frame members are partially superposed on each other, and the superposed surfaces are irradiated with a laser beam, thereby joining the two frame members together. This joining method has been often used as a joining method of joining frame members of a frame body of an image forming apparatus.

Galvanized steel sheets are often used for frame members forming a frame body of an image forming apparatus in order to secure rust preventiveness. When superposition welding is performed using steel sheets plated with a metal that has a boiling point lower than a melting point of a base metal sheet, such as galvanized steel sheets, vapor of the vaporized plating metal may remain between the superposed surfaces in close contact. The vapor of the plating metal creates blowholes in the fused and joined portion, and thus causes deterioration in welding quality.

Accordingly, in a jig or the like that superposes and supports frame members during welding, a pressing portion that presses the superposed surfaces so as to prevent the superposed surfaces from separating from each other is formed of an elastic member. In such a configuration, when metal vapor is generated, the pressing portion moves slightly, and thus a minute gap is defined between the members. The metal vapor is released from this minute gap between the members. The frame body of an image forming apparatus has a configuration in which a large number of frame members are mounted from a plurality of directions. Thus, the jig that supports the frame members is configured so as to cover the frame body, and hence is often large in scale.

Image forming apparatus are becoming larger in size along with an increase in speed. Further, there are an increasing number of image forming apparatus in which a plurality of modules having functions related to image formation are mounted on a plurality of frame bodies in a divided manner. The plurality of frame bodies have different modules to be mounted thereon, and hence differ in frame body structure. When large-scale jigs are used for welding the plurality of frame bodies, a plurality of large-scale jigs are preferred for the plurality of frame bodies, respectively, resulting in, for example, huge investment in jigs and huge man-hours required for setup and changeover during production.

As a joining method for a frame body, which does not use a large-scale jig, there is known a method of restraining the superposed surfaces from separating from each other by a fastening member such as a rivet as a temporary support for the frame members before welding, and then welding the frame members under a state in which the frame body is allowed to stand on its own without using a jig. However, in a case where the superposed surfaces of the frame members are temporarily supported by the fastening member, the fastening member has no elasticity, and hence a minute gap is not formed between the superposed surfaces of the frame members at the time when metal vapor is generated. Thus, it is difficult to release the metal vapor. Japanese Patent Application Laid-open No. 2014-94390 discloses a joining method in which a gap is defined by providing a step at a joining point formed by welding, to thereby form a ventilation channel for releasing the vapor of the plating metal. In this joining method, the gap is defined by a shape of the frame member. Accordingly, even after the frame members are temporarily supported, the ventilation channel is secured, and hence the metal vapor is removed.

However, as described above, the frame body of an image forming apparatus has the configuration in which a large number of frame members are mounted from a plurality of directions, and hence there are a large number of joining points at which the frame members are welded and joined together, and the joining points face in a plurality of directions. Accordingly, in a case where a gap is defined between the superposed surfaces by the shape of the frame member to secure the ventilation channel for the vapor of the plating metal, it is preferable to provide a step shape for each of a large number of welding points, resulting in complex shapes of the frame members. That is, in order to manufacture a frame body by intricately combining a plurality of frame members, the number of manufacturing steps for a frame member increases, and the number of faces of a die and manufacturing man-hours increase.

### SUMMARY

A joining method of joining a first metal sheet and a second metal sheet according to some embodiments of the present disclosure includes a fastening step of fastening the first metal sheet and the second metal sheet, which have been superposed on each other, by a fastening member at a fastening position, and a welding step of welding the first metal sheet and the second metal sheet, which have been superposed on each other, at a welding position, wherein, in a direction intersecting a sheet thickness direction of the first metal sheet, a distance between the fastening position and the welding position is set such that vapor generated between the first metal sheet and the second metal sheet during the welding step elastically deforms at least one of the first metal sheet and the second metal sheet to form a gap between the first metal sheet and the second metal sheet. A joining method of joining a first metal sheet and a second metal sheet according to another embodiment of the present disclosure includes a fastening step of fastening the first metal sheet and the second metal sheet, which have been superposed on each other, by a fastening member at a fastening position, and a welding step of welding the first metal sheet and the second metal sheet, which have been superposed on each other, at a welding position, wherein a distance between the fastening position and the welding position in a direction intersecting a sheet thickness direction of the first metal sheet is 30 mm or more.

A manufacturing method of an image forming apparatus according to yet another embodiment of the present disclosure includes preparing a frame body using a joining method of joining a first metal sheet and a second metal sheet including a fastening step of fastening the first metal sheet and the second metal sheet, which have been superposed on each other, by a fastening member at a fastening position, and a welding step of welding the first metal sheet and the second metal sheet, which have been superposed on each other, at a welding position, wherein, in a direction intersecting a sheet thickness direction of the first metal sheet, a distance between the fastening position and the welding position is set such that vapor generated between the first metal sheet and the second metal sheet during the welding step elastically deforms at least one of the first metal sheet and the second metal sheet to form a gap between the first metal sheet and the second metal sheet. A manufacturing method of an image forming apparatus according to yet another embodiment of the present disclosure includes preparing a frame body using a joining method of joining a first metal sheet and a second metal sheet including a fastening step of fastening the first metal sheet and the second metal sheet, which have been superposed on each other, by a fastening member at a fastening position, and a welding step of welding the first metal sheet and the second metal sheet, which have been superposed on each other, at a welding position, wherein a distance between the fastening position and the welding position in a direction intersecting a sheet thickness direction of the first metal sheet is 30 mm or more.

An image forming apparatus according to yet another embodiment of the present disclosure includes an image forming unit, and a frame body, which includes a first metal sheet and a second metal sheet joined together, and supports the image forming unit, wherein the first metal sheet and the second metal sheet are fastened together by a fastening member at a fastening position, wherein the first metal sheet and the second metal sheet are welded together at a welding position, and wherein a distance between the fastening position and the welding position in a direction intersecting a sheet thickness direction of the first metal sheet is 30 mm or more.

Further features of the present disclosure will become apparent from the following description of exemplary embodiments (with reference to the attached drawings).

### BRIEF DESCRIPTION OF THE DRAWINGS

FIG. 1 is an explanatory view for illustrating a joining method.

FIG. 2 is an explanatory view for illustrating the joining method.

FIG. 3 is a flowchart for illustrating the joining method.

FIGS. 4A, 4B, 4C, 4D, and 4E are each a schematic sectional view for illustrating a region near a joining point during welding.

FIG. 5 is an explanatory graph for showing a relationship between a gap and tensile strength of a steel sheet.

FIG. 6 is an explanatory graph for showing a relationship between a distance and the tensile strength.

FIG. 7 is an explanatory graph for showing a relationship between the distance and a rate of occurrence of blowholes.

FIG. 8 is a configuration view for illustrating an ink-jet recording apparatus.

FIG. 9 is a configuration view for illustrating an example of a frame body of a fixing module.

FIG. 10 is a configuration view for illustrating an example of a bottom plate frame.

FIG. 11 is an exploded view for illustrating a fixing frame.

FIG. 12 is a configuration view for illustrating a state in which each frame of the fixing frame is temporarily supported.

FIG. 13 is an enlarged view for illustrating a region B of FIG. 12.

FIG. 14 is an explanatory view for illustrating a state in which the fixing frame before a joining step is mounted on a welding apparatus.

FIG. 15 is an enlarged view for illustrating the region B of FIG. 12 after joining.

FIG. 16 is an explanatory view for illustrating a related-art temporary support jig for welding a frame body.

FIGS. 17A, 17B, and 17C are each an explanatory view for illustrating a related-art frame joining method.

FIG. 18 is an explanatory view for illustrating a state in which the temporary support jig supports each frame therein.

FIG. 19 is an explanatory view for illustrating a state in which the temporary support jig is mounted on the welding apparatus.

### DESCRIPTION OF THE EMBODIMENTS

Now, referring to the accompanying drawings, description is given of various exemplary embodiments, features, and aspects of the present disclosure. Regarding a joining method and a frame structure of an image forming apparatus as described in this embodiment, dimensions, materials, shapes, relative arrangements, and the like of component parts as described are not intended to limit the scope of the present disclosure only thereto, unless otherwise specifically stated.

### Joining Method

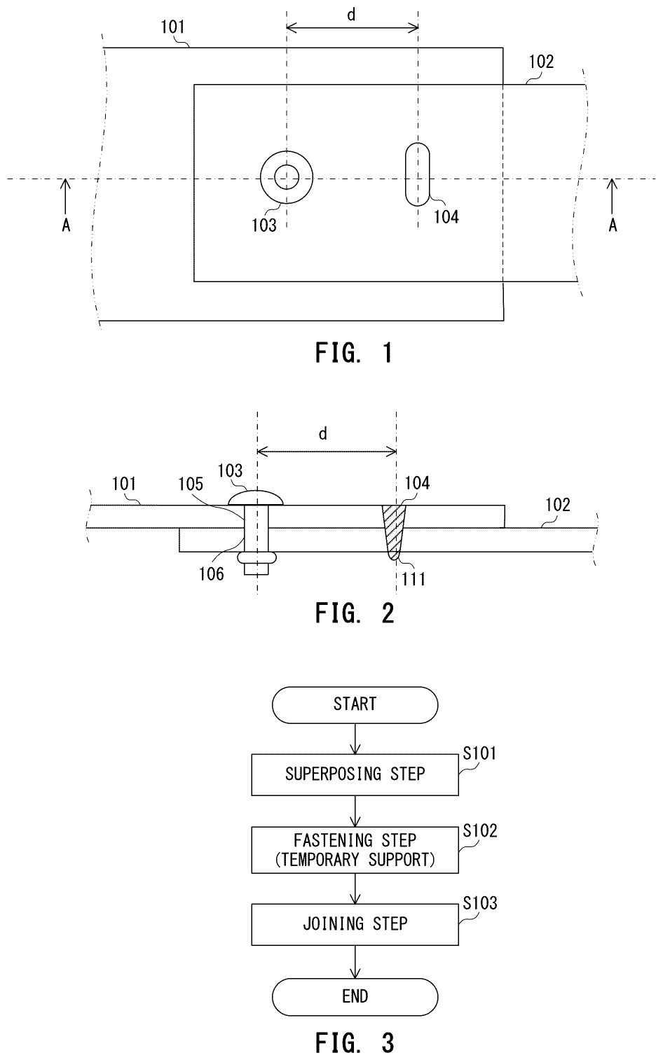

FIG. 1 and FIG. 2 are each an explanatory view for illustrating a joining method according to this embodiment. Here, description is given of a method of welding galvanized steel sheets, which are metal sheets with metallicity to be joined. FIG. 1 is a top view for illustrating galvanized steel sheets joined by the joining method according to this embodiment. FIG. 2 is a schematic sectional view for illustrating a region near a joining point.

A first galvanized steel sheet 101 and a second galvanized steel sheet 102 are arranged so as to partially superposed on each other. A hole 105 is formed in the first galvanized steel sheet 101, a hole 106 is formed in the second galvanized steel sheet 102, and a rivet 103 is provided through the hole 105 and the hole 106. The rivet 103 fastens the first galvanized steel sheet 101 and the second galvanized steel sheet 102 so as to prevent superposed surfaces of the first galvanized steel sheet 101 and the second galvanized steel sheet 102 from separating from each other. A joining point 104 (welding position) formed by laser welding is present at a position apart by a predetermined distance “d” from a center of the rivet 103 (fastening position) in a direction intersecting a sheet thickness direction of the first galvanized steel sheet 101 (or second galvanized steel sheet 102). On the second galvanized steel sheet 102, a protrusion 111 is formed as a mark of laser welding.

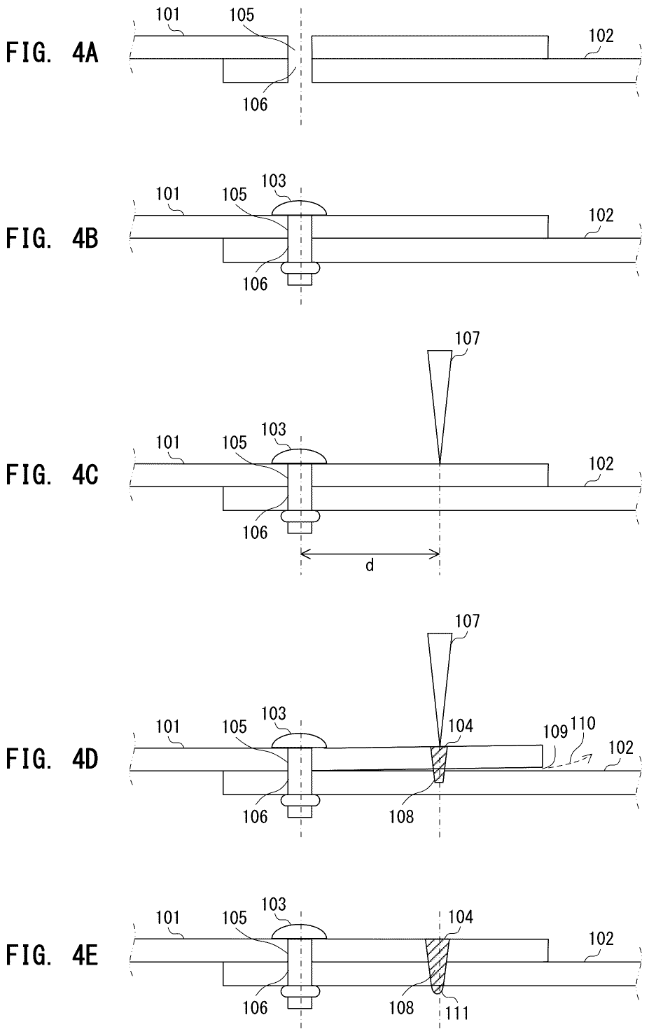

FIG. 3 is a flowchart for illustrating the joining method of performing such laser welding. FIGS. 4A to 4E are each a schematic sectional view for illustrating a region near the joining point during welding.

When laser welding is started, first, a part of the first galvanized steel sheet 101 and a part of the second galvanized steel sheet 102 are superposed so as to be in close contact with each other (Step S101). FIG. 4A shows, as an example, the first galvanized steel sheet 101 and the second galvanized steel sheet 102 during a superposing step. The hole 105 formed in the first galvanized steel sheet 101 and the hole 106 formed in the second galvanized steel sheet 102 are aligned so as to be substantially coaxial with each other.

After the superposing step, the first galvanized steel sheet 101 and the second galvanized steel sheet 102 are fastened to each other as temporary support so that the superposed surfaces of the first galvanized steel sheet 101 and the second galvanized steel sheet 102 are prevented from separating from each other in the vertical direction (Step S102). Specifically, as illustrated in FIG. 4B, the rivet 103 is inserted as a fastening member through the hole 105 and the hole 106 that have been aligned so as to be substantially coaxial with each other. The rivet 103 fastens the first galvanized steel sheet 101 and the second galvanized steel sheet 102 to each other. The fastening step prevents contact surfaces of the first galvanized steel sheet 101 and the second galvanized steel sheet 102 from separating from each other.

After the fastening step, the first galvanized steel sheet 101 and the second galvanized steel sheet 102 are joined to each other by welding (Step S103). In the joining step, specifically, as illustrated in FIG. 4C, a laser beam 107 output from a laser welding apparatus (not shown) is radiated to a position apart by a predetermined distance “d” from the center of the rivet 103 (fastening position). The radiation of the laser beam 107 forms a molten pool 108 in the first galvanized steel sheet 101 and the second galvanized steel sheet 102 as illustrated in FIG. 4D. When the molten pool 108 solidifies, the first galvanized steel sheet 101 and the second galvanized steel sheet 102 are joined to each other. A position irradiated with the laser beam 107 is the joining point 104 between the first galvanized steel sheet 101 and the second galvanized steel sheet 102.

With the irradiation with the laser beam, both the first galvanized steel sheet 101 and the second galvanized steel sheet 102 generate vapor of zinc, which is a plating metal. This is because a boiling point of zinc, which is a metal to be used as a coating material for coating the surfaces of the first galvanized steel sheet 101 and the second galvanized steel sheet 102, is lower than a melting point of a steel sheet (iron) being a base metal. In a case where the surfaces of the first galvanized steel sheet 101 and the second galvanized steel sheet 102 cannot be separated from each other between the superposed surfaces thereof, zinc vapor remains in the molten pool 108 because there is no place for the zinc vapor to escape. This causes, for example, blowholes to occur.

In this embodiment, the joining point 104 is at a position apart by a predetermined distance “d” from the rivet 103 that restrains the first galvanized steel sheet 101 and the second galvanized steel sheet 102 from separating from each other. Accordingly, when zinc vapor is generated between the superposed surfaces of the first galvanized steel sheet 101 and the second galvanized steel sheet 102, at least one of the first galvanized steel sheet 101 and the second galvanized steel sheet 102 can deflect due to elastic deformation (FIG. 4D). In FIG. 4D, a steel sheet portion of the base metal of the first galvanized steel sheet 101 is melted by the laser beam 107 to form the molten pool 108. When zinc vapor is generated, a portion, on a distal end side from the molten pool 108, of the first galvanized steel sheet 101 is lifted due to the zinc vapor, thereby causing the first galvanized steel sheet 101 to deflect. Thus, a gap 109 is formed between the superposed surfaces during a period in which welding is performed. The zinc vapor can be released from the gap 109 as an exhaust air 110.

When the joining step is completed, as illustrated in FIG. 4E, the protrusion 111 is formed on the surface of the first galvanized steel sheet 101 or the second galvanized steel sheet 102 by welding. The protrusion 111 is not necessarily formed on both of the first galvanized steel sheet 101 and the second galvanized steel sheet 102, and may be formed on any one of the first galvanized steel sheet 101 and the second galvanized steel sheet 102. Alternatively, the surface of the first galvanized steel sheet 101 or the surface of the second galvanized steel sheet 102 may be dented at the joining point 104. The gap 109 formed due to elastic deformation becomes smaller as the shape of first galvanized steel sheet 101 or second galvanized steel sheet 102 that has been deformed is restored to the original shape after the joining step. However, the molten pool 108 may flow into the gap 109, and in this case, the shape of the gap 109 may not be restored to a shape before the joining step.

### Tensile Strength at Joining Point

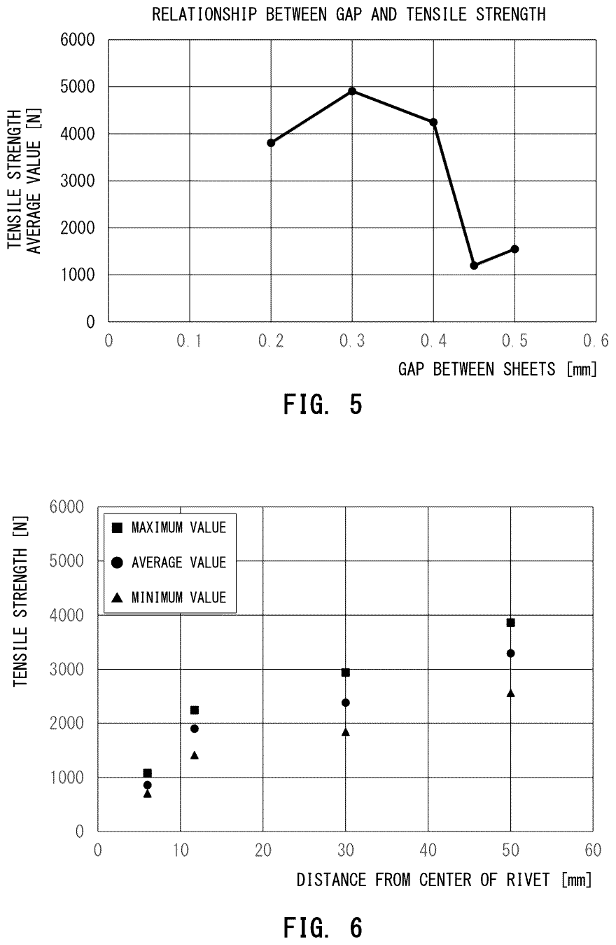

FIG. 5 is an explanatory graph for showing a relationship between the gap 109 and the tensile strength of the steel sheets when the first galvanized steel sheet 101 and the second galvanized steel sheet 102 are superposed and welded to each other. As shown in FIG. 5, the weld strength is significantly reduced in a case where the gap 109 between the first galvanized steel sheet 101 and the second galvanized steel sheet 102 exceeds 0.4 millimeter (mm). For this reason, preferably, the gap 109 formed between the superposed surfaces of the first galvanized steel sheet 101 and the second galvanized steel sheet 102 does not exceed 0.4 mm.

FIG. 6 is an explanatory graph for showing a relationship between the distance “d” from the center of the rivet 103 (fastening position) being the fastening member to the joining point 104 formed by welding, and the tensile strength. The rivet 103 restrains the separation between the first galvanized steel sheet 101 and the second galvanized steel sheet 102. Further, the tensile strength at the joining point 104 tends to decrease significantly as the distance “d” from the center of the rivet 103 to the joining point 104 becomes smaller.

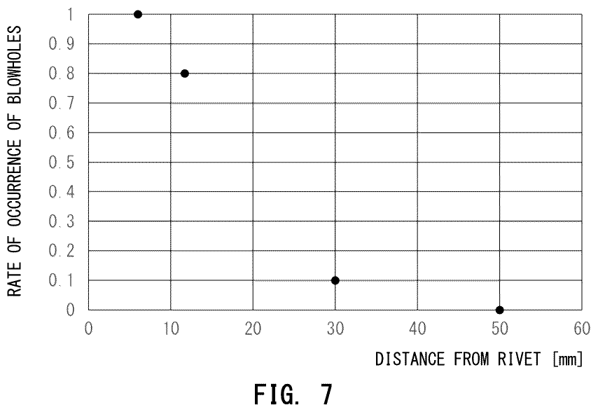

FIG. 7 is an explanatory graph for showing a relationship between the distance “d” from the center of the rivet 103 (fastening position) to the joining point 104 and a rate of occurrence of blowholes. The rate of occurrence of blowholes tends to increase significantly as the distance “d” becomes smaller. From FIG. 7, it is conceivable that the phenomenon described with reference to FIG. 6, in which the tensile strength at the joining point 104 decreases as the distance “d” from the center of the rivet 103 to the joining point 104 becomes smaller, is mainly caused by the occurrence of blowholes. Accordingly, by setting the distance “d” between the center of the rivet 103 and the joining point 104 to a predetermined distance or more, the occurrence of blowholes can be suppressed and the tensile strength can be stabilized more.

In this embodiment, description is given of an example of welding, as an article to be joined, a thin sheet formed of a galvanized steel sheet, which is mainly used for a frame body of an image forming apparatus. The galvanized steel sheet is assumed to have a sheet thickness of from 0.8 mm to 3.2 mm. The target tensile strength at the joining point formed by welding is 1500 newtons (N) or more. Accordingly, the distance “d” from the center of the rivet 103 to the joining point 104 is set to 30 mm or more with respect to the largest sheet thickness of 3.2 mm.

Considering a relationship between deflection of a beam and a sectional secondary moment, it can be seen that the distance “d” is proportional to the sheet thickness of the galvanized steel sheet. Accordingly, it is preferred that the distance “d” be at least 9.3 times the sheet thickness. In this case, the sheet thickness is the sheet thickness of the steel sheet of one of the first galvanized steel sheet 101 and the second galvanized steel sheet 102, which has a larger amount of deflection when the gap 109 is formed. Normally, the sheet thickness in this case is the sheet thickness of the first galvanized steel sheet 101. A position at which the tensile strength at the joining point 104 is not much needed, the distance “d” from the center of the rivet 103 to the joining point 104 may be less than 9.3 times the sheet thickness.

In a case where the distance from the rivet 103 is excessively large, the gap between the steel sheets tends to increase due to deflection caused by the self-weight of the galvanized steel sheet, warpage during processing, and the like. Accordingly, in this embodiment, the distance “d” is 250 mm or less so that the gap between the steel sheets is 0.4 mm or less. Similarly to the foregoing, this configuration may not apply to the position at which the tensile strength at the joining point is not much needed.

In the joining method according to this embodiment, it is not necessary to provide a part shape such as a step for the release of zinc vapor when superposition welding in which plate-like steel sheets (metal sheets) are superposed and welded to each other by laser welding is performed. Further, the joining method according to this embodiment does not need, for example, a step of performing laser irradiation twice, such as performing main welding after removing zinc from the welded surface by laser beam irradiation, or a jig capable of forming a ventilation channel for releasing zinc vapor. In the joining method according to this embodiment, two thin steel sheets are temporarily supported by the rivet 103, and then joined to each other by radiating a laser beam to a position apart by a predetermined distance “d” from the fastening position of the rivet 103. In this way, in this embodiment, it is possible to perform welding that prevents deterioration of welding quality due to, for example, occurrence of blowholes.

In this embodiment, description has been given of the case in which zinc is used as a plating material with a boiling point lower than the melting point of the steel sheet being the base metal, but the plating material is not limited thereto. Description has been given of the case in which the rivet is used as the fastening member for suppressing separation in a plane direction before the welding step, but the fastening member is not limited thereto as long as the fastening member suppresses separation in the plane direction. It is only preferable that the steel sheet from which zinc vapor is generated be at least one of the first galvanized steel sheet 101 and the second galvanized steel sheet 102. Welding is performed by heating with a laser beam. However, the heating method is not limited to the laser beam, and may be any other known heating method in the art of welding (for example, electricity, arc discharge, gas, plasma, and electron beam).

### Operational Form

The frame body structure of an image forming apparatus using the joining method according to this embodiment is described. Here, an ink-jet recording apparatus is described as an example of the image forming apparatus.

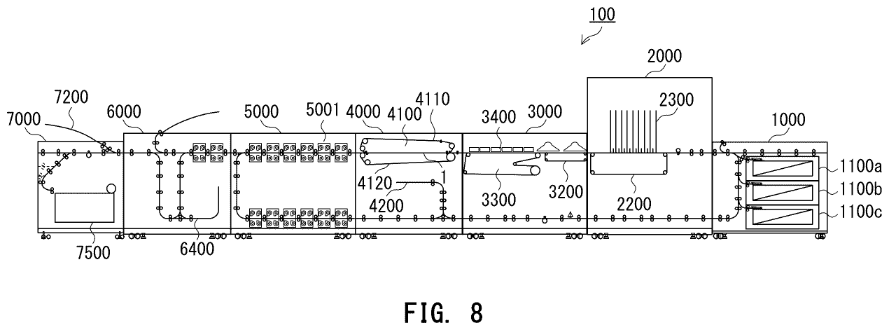

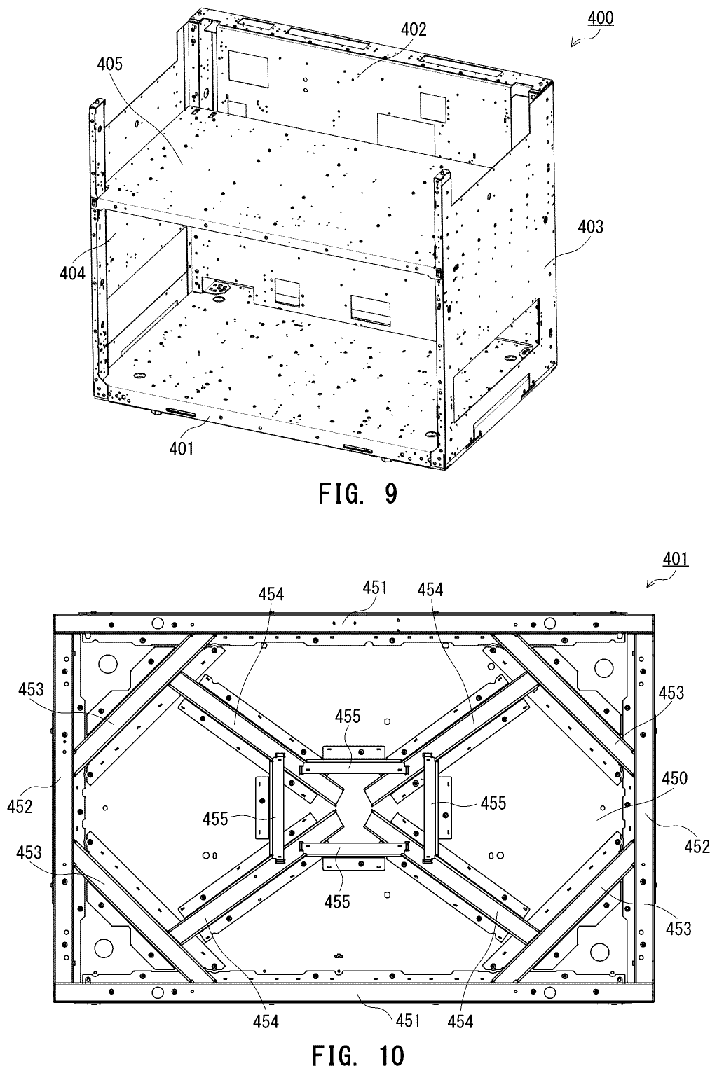

FIG. 8 is a configuration view for illustrating an ink-jet recording apparatus. An ink-jet recording apparatus 100 according to this embodiment is a sheet-fed image forming apparatus that forms an ink image on a sheet using two liquids, specifically, a reaction liquid and an ink to produce a printed product. The ink-jet recording apparatus 100 includes a sheet feeding module 1000, a printing module 2000, a drying module 3000, a fixing module 4000, a cooling module 5000, a reversing module 6000, and a sheet discharging and stacking module 7000. A cut paper-like sheet on which an image is to be printed is fed from the sheet feeding module 1000, subjected to predetermined processing by each module, and discharged to the sheet discharging and stacking module 7000.

The sheet feeding module 1000 includes a plurality of sheet storage portions 1100a to 1100c (three tiers in this embodiment). Each of the sheet storage portions 1100a to 1100c can store sheets therein. Each of the sheet storage portions 1100a to 1100c is configured to be capable of being drawn toward a front side of the apparatus, and sheets are stored in each sheet storage portion after the sheet storage portion is drawn toward the front side of the apparatus. The sheet feeding module 1000 feeds sheets one by one to the printing module 2000. Thus, each of the sheet storage portions 1100a to 1100c includes a separation belt and conveyance rollers. The number of the sheet storage portions 1100a to 1100c is an example, and may be one, two, or four or more.

The printing module 2000 is an image forming unit that forms an image on a sheet fed from the sheet feeding module 1000. The printing module 2000 includes a pre-image-forming registration correction unit (not shown), a print belt unit 2200, and a recording unit 2300. The pre-image-forming registration correction unit corrects an inclination and a position of the sheet fed from the sheet feeding module 1000, and conveys the sheet to the print belt unit 2200.

The print belt unit 2200 and the recording unit 2300 are arranged on a downstream side of the pre-image-forming registration correction unit in a sheet conveying direction so as to be opposed to each other across a sheet conveyance path. The print belt unit 2200 conveys, through suction, a sheet to be conveyed from the pre-image-forming registration correction unit. The recording unit 2300 is a sheet processing unit that performs recording processing (printing) from above by a recording head to form an image on the sheet conveyed by the print belt unit 2200. The recording head performs printing by ejecting the ink onto the sheet. The sheet is conveyed through suction by the print belt unit 2200, and thus a constant clearance between the recording head and the sheet is maintained.

A plurality of recording heads are arranged along the sheet conveying direction. The recording heads in this embodiment are five line-type recording heads corresponding to four colors of Y (yellow), M (magenta), C (cyan), and K (black), and the reaction liquid. The number of colors and the number of recording heads are not limited to five. As the ink-jet system, a system using a heat generating element, a piezoelectric element, an electrostatic element, or a micro-electromechanical system (MEMS) element can be adopted. The ink of each color is supplied to the recording head from an ink tank (not shown) through an ink tube.

The sheet printed in the recording unit 2300 is conveyed by the print belt unit 2200. An in-line scanner (not shown) is arranged on a downstream side of the recording unit 2300 in the conveying direction. The in-line scanner is used in order to detect misalignment and color density of the image formed on the sheet and to correct an image to be printed.

The drying module 3000 dries the sheet on which the image has been formed by the printing module 2000. The drying module 3000 dries the sheet to reduce a liquid component contained in the ink, thereby improving fixability between the sheet and the ink. The drying module 3000 includes a decoupling unit 3200, a drying belt unit 3300, and a warm air blowing unit 3400.

The sheet printed in the recording unit 2300 of the printing module 2000 is conveyed to the decoupling unit 3200 in the drying module 3000. The decoupling unit 3200 weakly holds and conveys the sheet by air pressure from above and belt friction. This prevents displacement of the remaining portion of the sheet on the print belt unit 2200 under a state in which the sheet extends astride the decoupling unit 3200 and the print belt unit 2200.

The sheet conveyed from the decoupling unit 3200 is conveyed through suction to the drying belt unit 3300, and at the same time, hot air is blown to the sheet from the warm air blowing unit 3400 arranged above the belt to dry the ink application surface (image printed surface). In addition to the hot air blowing method, the drying method may include a combination of a method of irradiating the sheet surface with electromagnetic waves (such as ultraviolet rays and infrared rays) and a conduction heat transfer method through contact of heating elements.

The fixing module 4000 fixes the image on the sheet by heating the sheet dried in the drying module 3000 and by drying the ink. The fixing module 4000 includes a fixing belt unit 4100 including an upper belt unit 4110 and a lower belt unit 4120. The fixing module 4000 causes the sheet conveyed from the drying module 3000 to pass between the heated upper belt unit 4110 and lower belt unit 4120, and thus causes (fixes) the ink solvent to fully permeate the sheet.

The cooling module 5000 cools the sheet on which the image has been fixed by the fixing module 4000, and thus solidifies the ink softened by heating and suppresses a temperature change of the sheet caused by downstream devices. The cooling module 5000 includes a plurality of cooling units 5001. The plurality of cooling units 5001 cool the high-temperature sheet conveyed from the fixing module 4000. Each cooling unit 5001 is configured to cool a sheet by taking outside air into a cooling box with a fan to increase the pressure in the cooling box, and by exposing the sheet to air blown out from nozzles formed in a conveyance guide. The plurality of cooling units 5001 are arranged on both sides of the conveyance path, and hence can cool the sheet from both sides.

A conveyance path switching unit is provided in the cooling module 5000. The conveyance path switching unit switches conveyance paths for the sheet according to whether the sheet is conveyed to the reversing module 6000 or to a double-sided printing conveyance path to be used for double-sided printing.

During double-sided printing, the sheet is conveyed to the lower conveyance path in the cooling module 5000, and is conveyed through the double-sided printing conveyance paths of the fixing module 4000, the drying module 3000, the printing module 2000, and the sheet feeding module 1000. A double-sided printing conveyance unit of the fixing module 4000 is provided with a first reversing unit 4200 that reverses the front and back surfaces of the sheet. After the sheet is once conveyed to the first reversing unit 4200, the sheet is reversed and conveyed to the drying module 3000 side, and thus the printed surface with the image is reversed. Owing to conveyance of the sheet through the first reversing unit 4200, printing can be performed on the back surface of the sheet. The sheet is then conveyed again to the pre-image-forming registration correction unit, the print belt unit 2200, and the recording unit 2300 of the printing module 2000, and printing is performed on the sheet.

The reversing module 6000 includes a second reversing unit 6400. The reversing module 6000 can reverse, by the second reversing unit 6400, the front and back surfaces of the sheet to be conveyed. Thus, the orientation of the front and back surfaces of the sheet to be discharged can be changed. The sheet discharging and stacking module 7000 includes a top tray 7200 and a stacking unit 7500. The sheet discharging and stacking module 7000 aligns and stacks the sheets conveyed from the reversing module 6000 onto the top tray 7200 or the stacking unit 7500.

### Frame Body Configuration

As described above, the ink-jet recording apparatus 100 is divided into the sheet feeding module 1000, the printing module 2000, the drying module 3000, the fixing module 4000, the cooling module 5000, the reversing module 6000, and the sheet discharging and stacking module 7000. The ink-jet recording apparatus 100 includes, for each module, a frame body for supporting an internal configuration of each module. The frame bodies have different configurations because the frame bodies support different internal configurations, respectively. Here, the frame body of the fixing module 4000 is described.

FIG. 9 is a configuration view for illustrating an example of the frame body of the fixing module 4000. The frame body of the fixing module 4000 is referred to as “fixing frame.” The fixing frame 400 is formed of a bottom plate frame 401, a rear frame 402, a right frame 403, a left frame 404, and a center shelf 405 that are joined together. The bottom plate frame 401, the rear frame 402, the right frame 403, the left frame 404, and the center shelf 405 are each formed of a plurality of frame members that are joined together.

Now, the configuration of the bottom plate frame 401 is described. FIG. 10 is a configuration view for illustrating an example of the bottom plate frame 401. The bottom plate frame 401 is formed of seventeen frame members of six types including: a bottom plate 450; two lateral beams 451; two longitudinal beams 452; four end diagonal beams 453; four center diagonal beams 454; and four center connecting beams 455. The frame members are joined together by welding after being combined with each other.

Similarly, the rear frame 402, the right frame 403, the left frame 404, and the center shelf 405 are each formed of a plurality of frame members, which are similarly joined together by welding after the frame members are combined with each other. In order to suppress deformation of the frame members due to welding, welding to be used for joining the frame members together is preferably superposition welding by laser welding, which has a relatively small amount of heat input to the frame members. In particular, welding by the above-mentioned joining method according to this embodiment is preferred. Accordingly, superposition welding by laser welding is mainly used for joining the frame members together.

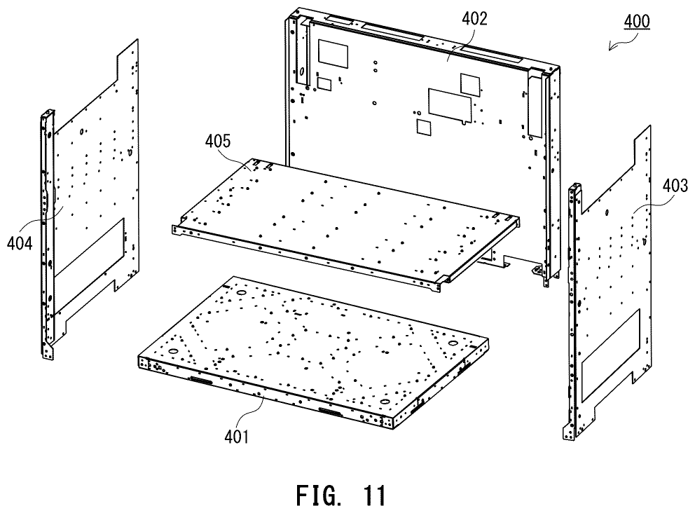

FIG. 11 is an exploded view for illustrating the fixing frame 400. The bottom plate frame 401, the rear frame 402, the right frame 403, the left frame 404, and the center shelf 405 are each produced by joining the plurality of frame members together as described above. The fixing frame 400 is produced by combining the bottom plate frame 401, the rear frame 402, the right frame 403, the left frame 404, and the center shelf 405 and joining the frames together by welding. In a case of welding the bottom plate frame 401, the rear frame 402, the right frame 403, the left frame 404, and the center shelf 405 together, superposition welding by laser welding is also preferred for the same reasons as those for welding the frame members together. In particular, welding by the above-mentioned joining method according to this embodiment is preferred. Before the joining step by welding, temporary support is preferable for maintaining a proper gap between the frames.

### Temporary Support for Welding Frame Body

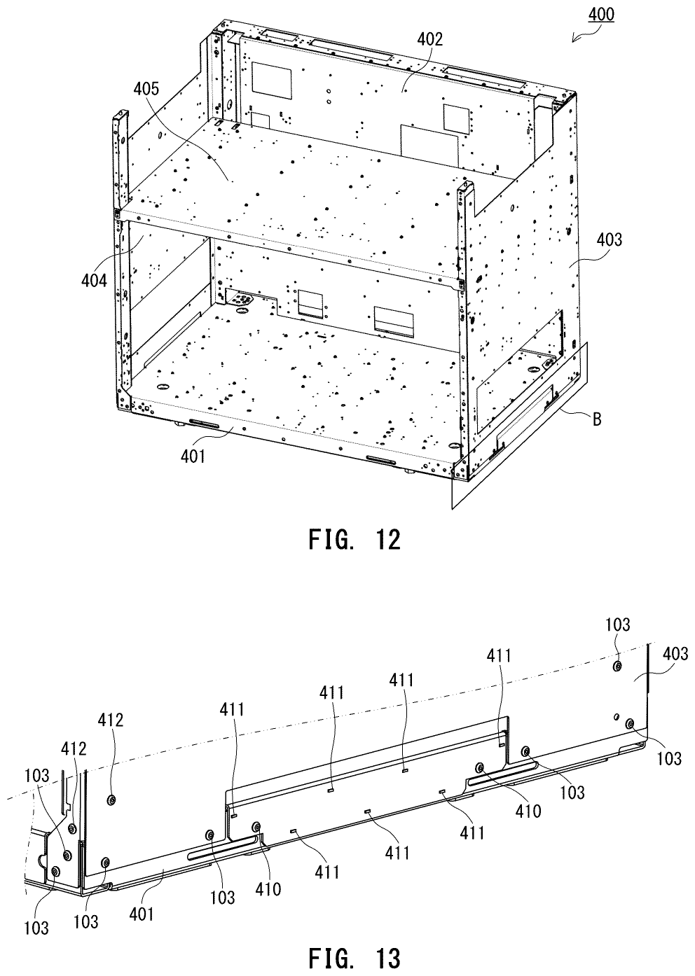

FIG. 12 is a configuration view for illustrating a state in which the frames of the fixing frame 400 are temporarily supported. FIG. 13 is an enlarged view for illustrating a region B of FIG. 12. In the related-art, each frame is temporarily supported using a jig (temporary support jig) for temporarily supporting the bottom plate frame 401, the rear frame 402, the right frame 403, the left frame 404, and the center shelf 405. However, in this embodiment, the frames are fastened to each other with the rivets 103, and hence the fixing frame 400 can stand on its own even in a state before welding.

As illustrated in FIG. 13, the bottom plate frame 401 has rivets 410 and joining points 411 used for joining the bottom plate frame 401. The right frame 403 similarly has rivets 412 and joining points (not shown) used for joining the right frame 403. To configure the fixing frame 400, the bottom plate frame 401 and the right frame 403 are temporarily supported by the plurality of rivets 103, and the superposed surfaces of the frames are restrained from separating from each other. Similarly, the rear frame 402, the left frame 404, and the center shelf 405 are also temporarily supported by the plurality of rivets 103. Accordingly, even before the frames are joined together by welding, the surfaces of the frames that are superposed on each other near the joining points to be formed by welding do not separate from each other, and the fixing frame 400 can stand on its own.

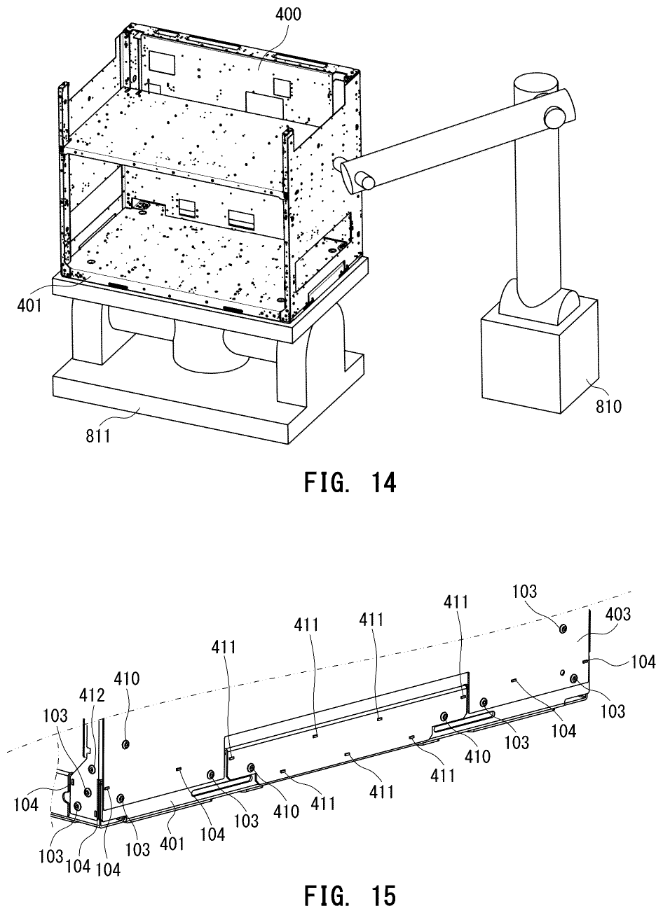

FIG. 14 is an explanatory view for illustrating a state in which the fixing frame 400 before the joining step is mounted on a welding apparatus. The welding apparatus is a laser welding apparatus configured to include a welding robot 810 and a rotary table 811. The fixing frame 400 to be welded is fixed on the rotary table 811. The welding robot 810 performs welding on the frames of the fixing frame 400 fixed on the rotary table 811.

The bottom plate frame 401 of the fixing frame 400 is directly fixed on the rotary table 811. The fixing frame 400 can stand on its own, and hence even in a temporarily supported state, the fixing frame 400 is fixed on the rotary table 811 through fixing the bottom plate frame 401.

In the frame body structure of the ink-jet recording apparatus 100 according to this embodiment, the bottom plate frame 401 has a substantially flat shape, and hence it is easy to fix the bottom plate frame 401 on the rotary table 811. Further, the shape for being fixed on the rotary table 811 can be standardized for the frame body structure of each module of the ink-jet recording apparatus 100. This eliminates the need to fix the jig for temporary support of each frame body on the rotary table 811 during the joining step of welding the frame body configuration of each module, and hence can significantly reduce the man-hours used to replace the frame body to be welded.

FIG. 15 is an enlarged view for illustrating the region B of FIG. 12 after joining (after welding). The bottom plate frame 401 and the right frame 403 are temporarily supported by the rivets 103, each of the joining points 104 is set at a position apart by a distance of 30 mm or more and 250 mm or less from the center of the rivet 103, and welding is performed on the joining points 104. When each of the joining points 104 is set at a position apart by a distance of 30 mm or more and 250 mm or less from the center of the rivet 103, a part of the steel sheet can be deformed elastically during welding, thereby allowing release of zinc vapor generated between the superposed surfaces. Further, the gap between two members (between two frames) to be welded can be set to 0.4 mm or less.

As described above, in this embodiment, a plurality of frames are temporarily supported by a joining member to produce the frame body of the image forming apparatus, thereby allowing the frame body to stand on its own. Then, the frames are joined together by performing laser welding on a position apart by a predetermined distance or more from the position of joining performed by the joining member. When the position apart by a predetermined distance or more from the joining position is set as the joining point to be formed by welding, the vapor of the plating metal is released from the gap 109 formed due to a minute change in at least one of the frames caused by elastic deformation when the vapor is generated from the plating metal. Accordingly, the occurrence of, for example, blowholes caused by the vapor of the plating metal can be suppressed, and the deterioration in welding quality can be prevented.

As described above, in the joining method according to this embodiment, unlike the related art, it is not necessary that the frame member have a step shape to release the vapor of the plating metal. Further, it is not necessary to use a jig capable of securing a ventilation channel as temporary support before the joining step by welding, or to provide a preliminary step such as removing zinc from the surface of the steel sheet by performing laser irradiation before the main welding. Accordingly, welding can be performed with significantly lower cost and less man-hours, and with less deterioration in welding quality than those of the related art.

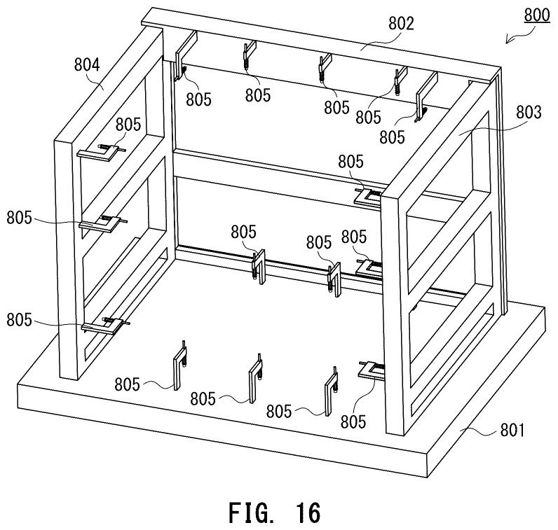

For reference, a related-art joining method is described. FIG. 16 is an explanatory view for illustrating a related-art temporary support jig for welding a frame body. A related-art temporary support jig 800 for welding a frame body includes a bottom plate support portion 801, a rear support portion 802, a right support portion 803, and a left support portion 804. Those support portions are separable from each other, and each include a plurality of frame pressing members 805. The bottom plate support portion 801 temporarily supports the bottom plate frame 401 with the plurality of frame pressing members 805. The rear support portion 802 temporarily supports the rear frame 402 with the plurality of frame pressing members 805. The right support portion 803 temporarily supports the right frame 403 with the plurality of frame pressing members 805. The left support portion 804 temporarily supports the left frame 404 with the plurality of frame pressing members 805.

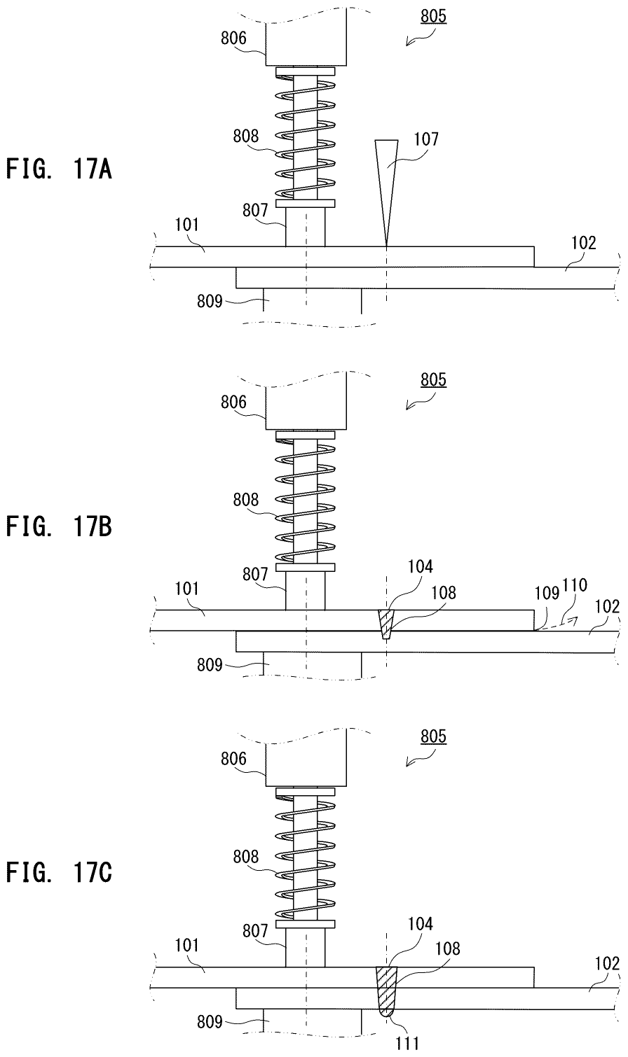

FIGS. 17A to 17C are each an explanatory view for illustrating a related-art frame joining method. The first galvanized steel sheet 101 and the second galvanized steel sheet 102, which form a frame, are pressed by the frame pressing members 805, and thus are prevented from separating from each other (FIG. 17A). The frame pressing member 805 prevents the separation between the steel sheets by urging a pressing portion 807 with a pressing spring 808 in a direction opposite to a support portion 806. A clearance between the pressing portion 807 and a frame receiving surface 809 is set to a value smaller than the sum of the sheet thickness of the first galvanized steel sheet 101 and the sheet thickness of the second galvanized steel sheet 102. For this reason, the pressing portion 807 presses the frame receiving surface 809 so as to prevent the two steel sheets from separating from each other. The vicinity of the frame pressing member 805 is irradiated with the laser beam 107. The gap formed between the first galvanized steel sheet 101 and the second galvanized steel sheet 102 is configured to be 0.4 mm or less.

The laser beam 107 forms the molten pool 108 in the first galvanized steel sheet 101 and the second galvanized steel sheet 102 (FIG. 17B). The zinc vapor generated between the steel sheets pushes up the first galvanized steel sheet 101, thereby causing the pressing spring 808 to contract slightly. Owing to the contraction of the pressing spring 808, the gap 109 is formed between the first galvanized steel sheet 101 and the second galvanized steel sheet 102. The zinc vapor is released from the gap 109 as the exhaust air 110. When welding by the laser beam 107 is completed, on the second galvanized steel sheet 102, the protrusion 111 is formed as a mark of laser welding (FIG. 17C).

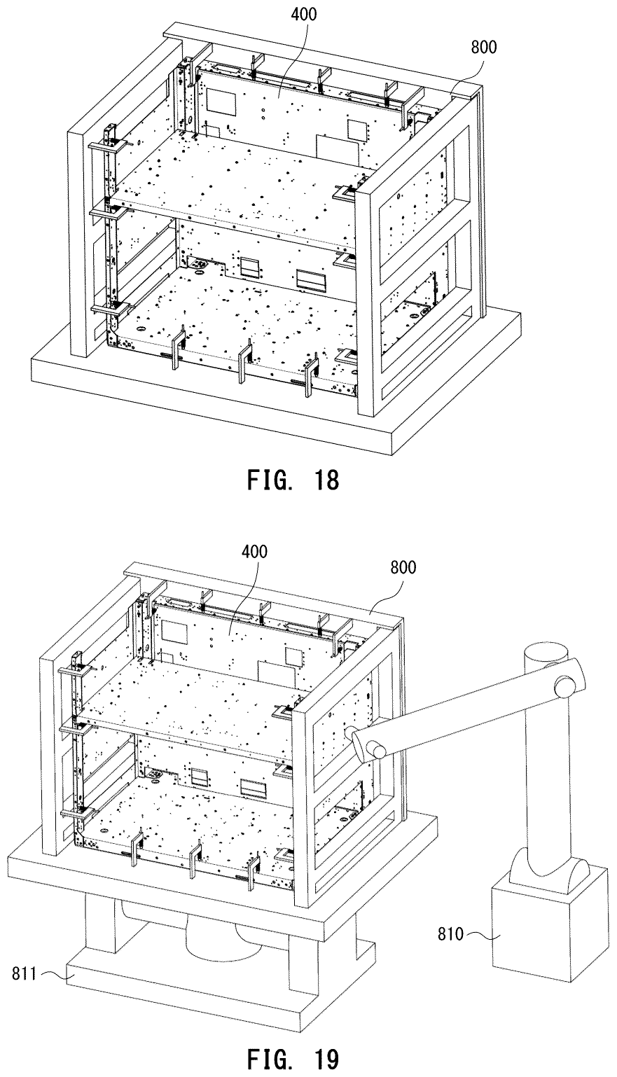

FIG. 18 is an explanatory view for illustrating a state in which the temporary support jig 800 supports each frame therein. The temporary support jig 800 for welding a frame body has the large-scale configuration because the temporary support jig 800 for welding a frame body has such a configuration as to cover a frame body in terms of the structure. FIG. 19 is an explanatory view for illustrating a state in which the temporary support jig 800 is mounted on the welding apparatus. When welding is performed on the fixing frame 400, the temporary support jig 800 is mounted on the rotary table 811 in order to perform welding from a plurality of directions. The temporary support jig 800 for welding a frame body is a large-sized jig, and hence the welding robot 810 and the rotary table 811 are also preferred to be large.

The ink-jet recording apparatus 100 may use seven types of frame bodies with different configurations. Accordingly, the temporary support jig 800 for welding a frame body is preferable for each of the frame bodies. Further, it is preferable to sequentially mount the large-scale temporary support jigs 800 for welding a frame body on the welding apparatus so as to perform welding, and hence the man-hours used for the joining step by welding are increased. When the joining method according to this embodiment is applied, the above-mentioned related-art temporary support jig 800 is not needed, and thus the man-hours used for the welding step can be significantly reduced as compared to the related art. Thus, according to the present disclosure, even in the frame body configuration in which a large number of metal sheets are mounted from a plurality of directions, it is possible to perform welding on the metal sheets while securing a ventilation channel for releasing metal vapor.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of priority from Japanese Patent Application No. 2024-025599, filed Feb. 22, 2024, which is hereby incorporated by reference herein in its entirety.

What is claimed is:

1. A joining method of joining a first metal sheet and a second metal sheet, the joining method comprising:
a fastening step of fastening the first metal sheet and the second metal sheet, which have been superposed on each other, by a fastening member at a fastening position; and
a welding step of welding the first metal sheet and the second metal sheet, which have been superposed on each other, at a welding position,
wherein, in a direction intersecting a sheet thickness direction of the first metal sheet, a distance between the fastening position and the welding position is set such that vapor generated between the first metal sheet and the second metal sheet during the welding step elastically deforms at least one of the first metal sheet and the second metal sheet to form a gap between the first metal sheet and the second metal sheet.

2. The joining method according to claim 1, wherein at least one of the first metal sheet and the second metal sheet includes:
a base metal, and
a coating material that has a boiling point lower than a melting point of the base metal, and coats the base metal.

3. The joining method according to claim 1, wherein the gap does not exceed 0.4 mm (millimeter) during a period in which the welding step is performed.

4. The joining method according to claim 1,
wherein the first sheet metal is deformed by the vapor to a larger extent than the second metal is, and
wherein the distance is at least 9.3 times a sheet thickness of the first metal sheet.

5. The joining method according to claim 4, wherein the first metal sheet and the second metal sheet each have a sheet thickness of from 0.8 mm (millimeter) to 3.2 mm (millimeter).

6. The joining method according to claim 1, wherein the distance is 30 mm (millimeter) or more.

7. The joining method according to claim 1, wherein the distance is 250 mm (millimeter) or less.

8. The joining method according to claim 1, wherein the fastening member is a rivet.

9. A joining method of joining a first metal sheet and a second metal sheet, the joining method comprising:
a fastening step of fastening the first metal sheet and the second metal sheet, which have been superposed on each other, by a fastening member at a fastening position; and
a welding step of welding the first metal sheet and the second metal sheet, which have been superposed on each other, at a welding position,
wherein a distance between the fastening position and the welding position in a direction intersecting a sheet thickness direction of the first metal sheet is 30 mm (millimeter) or more.

10. The joining method according to claim 9, wherein at least one of the first metal sheet and the second metal sheet includes:
a base metal; and
a coating material that has a boiling point lower than a melting point of the base metal, and coats the base metal.

11. The joining method according to claim 9,
wherein vapor generated between the first metal sheet and the second metal sheet during the welding step elastically deforms at least one of the first metal sheet and the second metal sheet to form a gap between the first metal sheet and the second metal sheet, and
wherein the gap does not exceed 0.4 mm (millimeter) during a period in which the welding step is performed.

12. The joining method according to claim 11,
wherein the first sheet metal is deformed by the vapor to a larger extent than the second metal is, and
wherein the distance is at least 9.3 times a sheet thickness of the first metal sheet.

13. The joining method according to claim 11, wherein the first metal sheet and the second metal sheet each have a sheet thickness of from 0.8 mm (millimeter) to 3.2 mm (millimeter).

14. The joining method according to claim 9, wherein the distance is 250 mm (millimeter) or less.

15. The joining method according to claim 9, wherein the fastening member is a rivet.

16. A manufacturing method of an image forming apparatus, comprising:
preparing a frame body using the joining method according to claim 1; and
providing an image forming unit to the frame body.

17. A manufacturing method of an image forming apparatus, comprising:
preparing a frame body using the joining method according to claim 9; and
providing an image forming unit to the frame body.

18. An image forming apparatus, comprising:
an image forming unit; and
a frame body, which includes a first metal sheet and a second metal sheet joined together, and supports the image forming unit,
wherein the first metal sheet and the second metal sheet are fastened together by a fastening member at a fastening position,
wherein the first metal sheet and the second metal sheet are welded together at a welding position, and
wherein a distance between the fastening position and the welding position in a direction intersecting a sheet thickness direction of the first metal sheet is 30 mm (millimeter) or more.

19. The image forming apparatus according to claim 18, wherein at least one of the first metal sheet and the second metal sheet includes:
a base metal; and
a coating material that has a boiling point lower than a melting point of the base metal, and coats the base metal.

20. The image forming apparatus according to claim 18, wherein the distance is 250 mm (millimeter) or less.
